(19) United States
(12) Patent Application Publication
(10) Pub. No.: US 2006/0283962 A1
(43) Pub. Date: Dec. 21, 2006

(54) Data encoding pattern

(75) Inventor: D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/155,779

(22) Filed: Jun. 20, 2005

(51) Int. Cl. G06K 19/06

(52) U.S. Cl. 235/494

(57) ABSTRACT

A product has a data encoding pattern thereon. The pattern is formed from groups of marks. Each group occupies a respective area of the product. The marks are of different colours and each group is arranged to have the same average colour.

### FIELD OF THE INVENTION

The present invention relates to data encoding systems in which a data encoding pattern is applied to a product, thereby encoding data, such as position identifying data, on the product, the pattern being readable by a suitable detection system used to read the data from the product. The product may be a document, such as a form, label or note pad, or any other form of product suitable for such marking, such as a packaging product.

### BACKGROUND TO THE INVENTION

It is known to use products, such as documents, having such position identification markings in combination with a pen having an imaging system, such as a camera, within it, which is arranged to image a small area of the product close to the pen nib. The pen includes a processor having image processing capabilities and a memory and is triggered by a force sensor in the nib to record images from the camera as the pen is moved across the document. From these images the pen can determine the position of any marks made on the document by the pen. The pen markings can be stored directly as graphic images, which can then be stored and displayed in combination with other markings on the document. In some applications the simple recognition that a mark has been made by the pen on a predefined area of the document can be recorded, and this information used in any suitable way. This allows, for example, forms with check boxes on to be provided and the marking of the check boxes with the pen detected. In further applications the pen markings are analysed using character recognition tools and stored digitally as text. Systems using this technology are available from Anoto AB.

It is known to use coloured marking materials, such as inks to produce the markings that make up the pattern. For example WO92/17859 describes a position indicating pattern in which data is encoded in the colours of adjacent squares of a pattern, and US2003/0066896 discloses a pattern in which a grid is defined and a dot associated with each grid intersection. The position of each dot relative to its intersection encodes one form of data, and another parameter, such as the colour of the dot, encodes other data.

### SUMMARY OF THE INVENTION

The present invention provides a product having a region of data encoding pattern thereon, the pattern being formed from groups of marks each group occupying a respective area of the product, wherein the marks are of different colours and the groups are arranged to have the same average colour as each other.

In some embodiments each group has a plurality of mark positions, each group has the same number of mark positions, and the pattern is arranged such that each mark position is characterised by at least one of: the presence of a mark of one of the colours; the colour of the mark; and the absence of a mark.

In some embodiments the areas occupied by the respective groups of dots are substantially the same size as each other. In some embodiments each group of marks is formed from the same number of marks. In some embodiments each of the marks is substantially the same size. In some embodiments the marks are formed

from marking materials of different marking material colours, and each of the groups is formed by applying substantially the same amount of marking material of each of the marking material colours to the product. In some embodiments each of the groups comprises the same number of marks of each of said colours. In some embodiments some of the marks are produced by the application of marking material of two different colours in the same mark position.

In some embodiments said groups are averaging groups and the marks are grouped spatially in spatial groups. In some embodiments the averaging groups are the same groups as the spatial groups. In some embodiments the spatial groups are defined by the spacing of the marks. In some embodiments the positioning of the marks in each spatial group is asymmetrical so that the orientation of the pattern can be at least partially determined from the positions of the marks.

In some embodiments each of the groups of marks is arranged to reflect light of substantially the same spectral content over the visible spectrum. In some embodiments each group of marks is arranged to reflect light that will produce substantially the same relative response in each of the cone types of the human eye.

The present invention further provides a method of generating a data encoding pattern, the method comprising defining the positions and colours of a plurality of groups of marks, such that each group is arranged to occupy a respective area, and such that the marks are of different colours and each group is arranged to have the same average colour.

In some embodiments the pattern is generated so that, when applied to the product, the pattern will have at least one of the characteristics of the product of the invention.

The present invention further provides a method of applying a data encoding pattern to a product, the method comprising generating a pattern according to the invention and applying the pattern to the product.

The present invention further provides a system for generating a data encoding pattern, the system being arranged to define the positions and colours of a plurality of groups of marks, such that each group is arranged to occupy a respective area, and such that the marks are of different colours and each group is arranged to have the same average colour.

The present invention further provides a system for applying a data encoding pattern to a product, the system being arranged to define the positions and colours of a plurality of groups of marks, such that each group is arranged to occupy a respective area, and such that the marks are of different colours and each group is arranged to have the same average colour, and to apply the pattern to the product.

The present invention further provides a data carrier carrying data arranged to control relevant systems to operate as a system according to the invention and to perform the methods of the invention. The data carrier can comprise, for example, a floppy disk, a CDROM, a DVD ROM/RAM (including +RW, −RW), a hard drive, a non-volatile memory, any form of magneto optical disk, a wire, a transmitted signal (which may comprise an internet download, an ftp transfer, or the like), or any other form of computer readable medium.

Embodiments of the present invention will now be described by way of example only with reference to the accompanying drawings.

### BRIEF DESCRIPTION OF THE DRAWINGS

FIG. 1 shows a document according to an embodiment of the invention and a digital pen for use with the document;

FIG. 2 shows a part of a position identifying pattern on the document of FIG. 1;

FIG. 3 shows a part of a position identifying pattern on the document according to a second embodiment of the invention;

FIG. 4 shows a part of a position identifying pattern on the document according to a third embodiment of the invention;

FIG. 5 shows a part of a position identifying pattern on the document according to a fourth embodiment of the invention;

FIG. 6 shows a part of a position identifying pattern on the document according to a fifth embodiment of the invention;

FIG. 7 shows a part of a position identifying pattern on the document according to a sixth embodiment of the invention;

FIG. 8 is a graph showing the spectral response of cones in the human eye; and

FIGS. 9 and 10 show a system for producing the document of FIG. 1.

### DESCRIPTION OF EMBODIMENTS

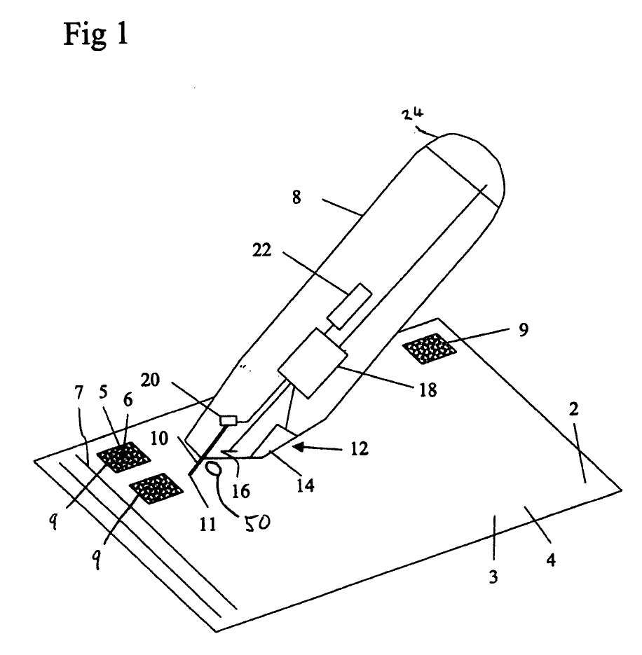

Referring to FIG. 1, a document 2, for use in a digital pen and paper system according to an embodiment of the invention, comprises a carrier 3 in the form of a single sheet of paper 4 with position identifying markings 5 printed on some parts of it. The markings 5, which are not shown to scale in FIG. 1, form a position identifying pattern 6 on areas of the document 2. Also printed on the paper 4 are further markings, including lines 7 and a number of boxes 9, which are clearly visible to a human user of the document 2, and which make up the content of the document 2. In this case each of the boxes 9 has a separate region of pattern associated with it.

The pen 8 comprises a writing nib 10, and a colour camera 12 made up of an LED 14 arranged to emit light over a range of frequencies, and a CCD or CMOS sensor array 16 arranged to sense light at a number of different frequencies, typically corresponding to red, green and blue visible light, so that it can form a colour image of a circular area adjacent to the tip 11 of the pen nib 10. A processor 18 processes images from the camera 12 taken at a predetermined rapid sample rate. A pressure sensor 20 detects when the nib 10 is in contact with the document 2 and triggers operation of the camera 12. Whenever the pen is being used on an area of the document 2 having the pattern 6 on it, the processor 18 can determine from the pattern 6 imaged by the camera 12 the position of the nib 10 of the pen at each sample time. From this it can determine the position and shape of any marks made by the pen nib 11 on the patterned areas of the document 2. This information is stored in a memory 22 in the pen as it is being used, and processed by the processor 18 as will be described in more detail below. The pen 8 further comprises a radio transceiver 24 which provides a Bluetooth radio link with an internet connected PC.

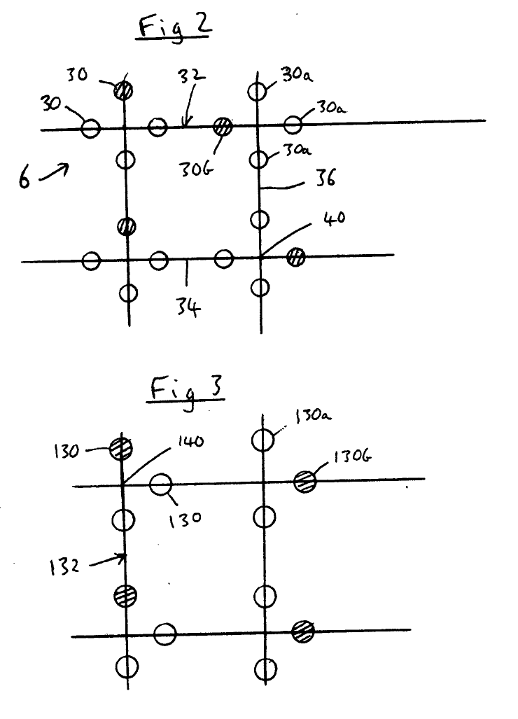

Referring to FIG. 2, part of the position identifying pattern 6 on the document 2 will now be described. The pattern 6 is made up of a number of graphical elements comprising coloured ink dots 30 arranged on an imaginary grid 32. The grid 32, which is shown in FIG. 2 for clarity but is not actually marked on the document 2, can be considered as being made up of horizontal and vertical lines 34, 36 defining a number of intersections 40 where they cross. The intersections 40 are of the order of 0.3 mm apart, and the dots 30 are of the order of 100 μm across. It will be appreciated that the dots are not shown to scale in FIG. 2. A group of four dots 30 are provided around each intersection 40, each offset slightly in one of four directions up, down, left or right, from the actual intersection 40. Each group of dots is made up of three dots 30a of one colour, in this case yellow, and one dot of a different colour 30b, in this case magenta.

It will be appreciated that, although the pattern is built up around a regular imaginary grid 32, the dots themselves are not completely evenly distributed across the document, but rather arranged in spatial groups. The dots 30 within each group are on average closer to the other dots in their group than to dots in other groups. Each dot is also closer to a dot in its own group, and in this case to two dots in its own group, than it is to any dots in any other group. This allows the spatial groups to be identified from the positions of the dots 30 on the document. In this case each spatial group occupies the same area of the document.

The position of the magenta dot in each group is arranged to vary in a systematic way so that any area of a sufficient number of groups of dots 30, for example any area of 36 groups arranged around a six by six square of grid intersections, will be unique within a very large area of the pattern. This large area is defined as a total imaginary pattern space, and only a small part of the pattern space is taken up by the pattern on the document 2.

Since each group of dots 30 contains the same number of dots 30 as every other group, and the same number of each colour dot as every other group, each group of dots 30 includes the same amount of ink of each colour. The average colour of each of the groups is therefore the same. Specifically the total reflectivity spectrum of each group is substantially the same, as each group of dots 30, if illuminated by the same light, will reflect the same amount of light at all visible wavelengths. This means that each group of dots, as perceived by a human user, has the same average colour. When the pattern is viewed from a normal distance, of for example 50 cm, the user's eye cannot distinguish the different coloured dots and the areas covered by the respective groups of dots all appear the same colour. This gives the pattern an even appearance over each region of pattern, which will typically include a large number of groups of dots, each covering a respective area within the region.

In this case, the regions of pattern in all of the boxes have the same average colour. However, in a modification to this embodiment, different regions of pattern on the document can have different average colours. What is important is that each region of pattern that needs to have a uniform appearance, whether it covers the whole document or only a part of it, has a uniform average colour.

Referring back to FIG. 1, when the pen 8 is held with its nib 10 in contact with the document 2, the camera 12 can view an area 50 of the document. This area covers approximately a square of 8 by 8 intersections 40, and is therefore large enough to ensure that there will always be a square of 6 by 6 intersections 40 for which all of the dots 30 are within the area. The processor 18 is therefore arranged to analyse each recorded image from the camera 12 to identify such a block of 36 groups of dots 30, identify each of the groups of dots 30 from their spacing, and identify all of the dot positions in the group, determine the position of the magenta dot in each group, and determine from the positions of the magenta dots the position and orientation of the viewed area on the document. From this information the position of the pen nib 10 on the document 2 can also be determined.

Referring to FIG. 3, in a second embodiment of the invention, the pattern is made up in a similar way to the first embodiment on an imaginary grid 132 with dots 130 arranged in groups around the grid intersections. In this case each group of dots 130 includes three dots, offset in three directions from the intersection point 140. The directions of the offsets for the dots are the same for each group. Because there are only three dots and they are offset in directions that are 90 degrees apart, the offset directions are not symmetrically spaced around the intersection point. Therefore the pattern has a directionality, in that the dot positions uniquely define a direction, and therefore all directions, on the document. For example, with the orientation as shown in FIG. 3, the direction to the left is the direction in which there is no dot 130 offset from each intersection 140. Clearly once one direction can be determined from the pattern, all directions can equally be defined. This directionality means that the colours of the dots only need to code sufficient data to identify position on the document, and do not need also to code the orientation. Again, with this embodiment each group of three dots has the same number of dots as every other group of each of two colours, in this case two yellow dots 130a and one magenta dot 130b. Each group is therefore produced from the same amount of ink of each colour, and therefore has the same average colour as perceived by the human eye.

When the pen 8 is used on a document having the pattern of FIG. 3 on it, it is again arranged to image an area of the pattern, and to identify the groups of dots making up the pattern. It is then arranged to determine the orientation of the pattern, and hence the document, relative to the pen, by identifying the three offset directions of the dots in each group. From the relationship between the positions of the dots, it can thus determine which dot is offset in which direction, and hence the orientation of the document relative to the pen. The pen 8 can then determine the position of the imaged area of the pattern from the positions of the different coloured dots in the pattern.

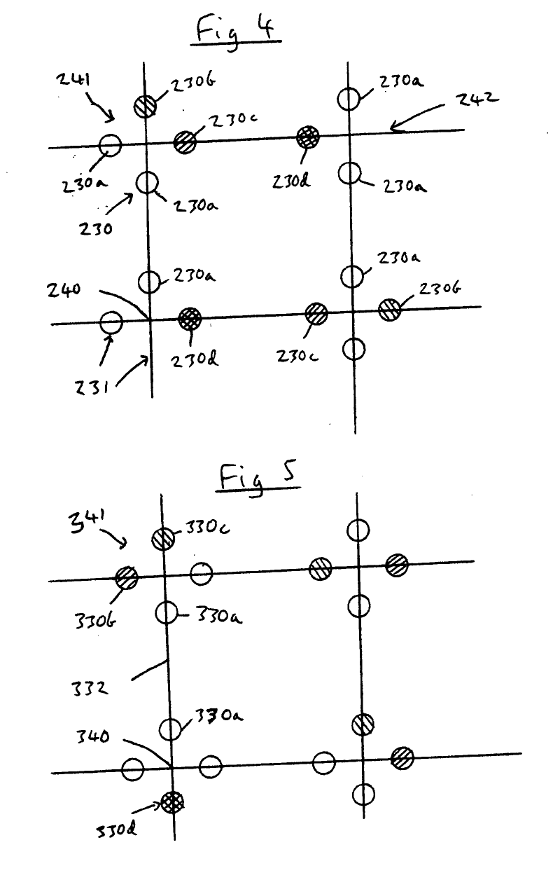

Referring to FIG. 4, in a further embodiment of the invention, each group of dots 230 is made up of a number of dots 230 located in any of four dot positions 231 spaced around the grid intersections 240 in the same four orthogonal offset directions as the previous embodiments. Again each group of dots is produced by applying the same number of single colour dots in the group. In this case each group is produced by applying two yellow dots 230a, one magenta dot 230b and one cyan dot 230c. However, the possible positions for the dots of each single colour are relaxed in that dots of different colours can be put in the same position thereby producing a composite dot. Therefore, while each group has the same number of dot positions, in which dots are either present or not, the groups do not all have the same number of dots. This can be achieved by printing a dot of one coloured ink on top of a dot of a different coloured ink, or by mixing inks of the two colours and printing the mixed ink onto the document in the dot position. Depending on the resolution of the printer, it may also be possible to print a number of very small areas of ink of one colour and a number of very small areas of ink of the other colour, these small areas being adjacent each other, so that the dot has the same appearance as if the inks were simply mixed. The colour of the composite dots obviously depends on the colours of ink from which they are made up. For example magenta and cyan together produce a blue dot 230d.

In this embodiment, while each group has the same number of dot positions, in which dots are either present or not, the groups do not all have the same number of dots. For some groups of dots, such as the group 241, all of the dot positions will be occupied and there will be the maximum number of four separate dots each formed from a single ink. In other groups, such as the group 242, there will be less than the maximum number of dots, and one or more of the dots will be composite dots made up of inks of more than one colour, with one or more of the dot positions left unoccupied.

In this arrangement, though there is not the same number of dots in each group, each group is made using the same amount of ink of each colour, and the same number of dots is applied to the document to produce each group. However, some of the dots are applied using two different colours of ink in the same dot position so that the resulting pattern is made up of groups of dots with different numbers of dots in each group. Clearly it would be possible for some groups to have three different coloured dots all superimposed on each other, or two composite dots each formed from two different coloured inks.

When the pen 8 is used on the document having the pattern of FIG. 4, the process it uses for determining its position is essentially the same as for the embodiment of FIG. 2. However, when analysing the image of an area of the pattern, the pen needs to be able to identify the number of dots 230 in each group 240 and also to distinguish between a higher number of colours, specifically each of the individual ink colours and each colour that can be formed from a combination of the inks. The pen therefore first identifies all of the dots, and from those identifies all of the dot positions, including those in which a dot is present and those in which no dot is present. Then from the characterising features of each of the dot positions, the data encoded on the pattern can be extracted. The data can then be used to determine the position and orientation of the document relative to the pen. In this case the characterising features include the presence or absence of a dot as well as its colour.

Referring to FIG. 5, in a further embodiment of the invention, the same grid structure 332 is used, and groups of four dots 330 around each grid intersection 340 with the same spacing as the embodiment of FIG. 1. In this case there are the same number of dots in each group, some of which are composite and some of which are produced with a single ink. Specifically one dot includes magenta ink, one dot includes cyan ink, and the dots are made up to a total of four with dots of yellow ink. The positions of the cyan and magenta ink dots can be different, or can be the same resulting in superposition and a composite dot. Therefore there can be either two or three dots of yellow ink only. In the example shown, one group 341 includes two yellow dots 330a, one magenta dot 330b and one cyan dot 330c, whereas another of the groups 342 includes three yellow dots 330a and one blue dot 330d formed from the superposition of a magenta dot and a cyan dot.

It will be appreciated that, in this embodiment, different amounts of yellow ink are used in different groups, although the same amounts of magenta and cyan are used. Therefore the average colour of all of the groups is not exactly the same. However, difference in the amount of ink in different groups is limited to enough yellow ink to make one dot. Therefore the variation in the amount of yellow ink in different groups is limited and relatively small, and all groups have the same amount of cyan and magenta ink. The resulting pattern therefore has an even appearance because the average colour of the groups only varies by a small, controlled, amount.

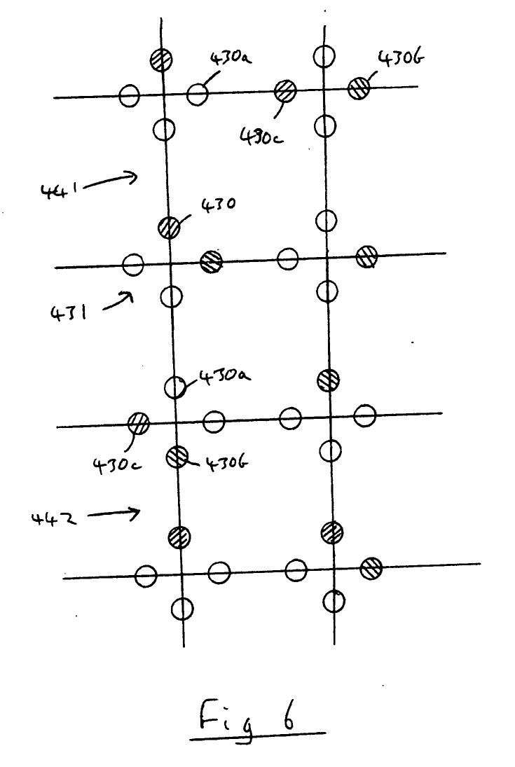

Referring to FIG. 6, in a further embodiment the pattern is very similar to that of FIG. 1, with each spatial group 431 including four dots 430, each formed from a single ink of either yellow, cyan or magenta. However, in this embodiment the averaging of colour is not made over individual groups of four dots, but larger groups or areas including four of the spatial groups. Specifically, each averaging group of four spatial groups has the same number of dots of each colour, and therefore has the same amount of ink of each colour. In this case the averaging group made up of the top four spatial groups 441 shown have a total of ten yellow dots 430a, three magenta dots 430b and three cyan dots 430c. However, within each spatial group of four dots, the number of each colour varies. Similarly the averaging group made up of the bottom four spatial groups 442 has the same number of each colour in total, but again with different numbers of each colour in each spatial group.

When the pen 8 is used with this pattern, the position identifying method is the same as with the embodiment of FIG. 1. However, the greater flexibility in the positions of the different coloured dots means that more data can be encoded in a similar area of pattern, and therefore a greater total area of pattern can be defined.

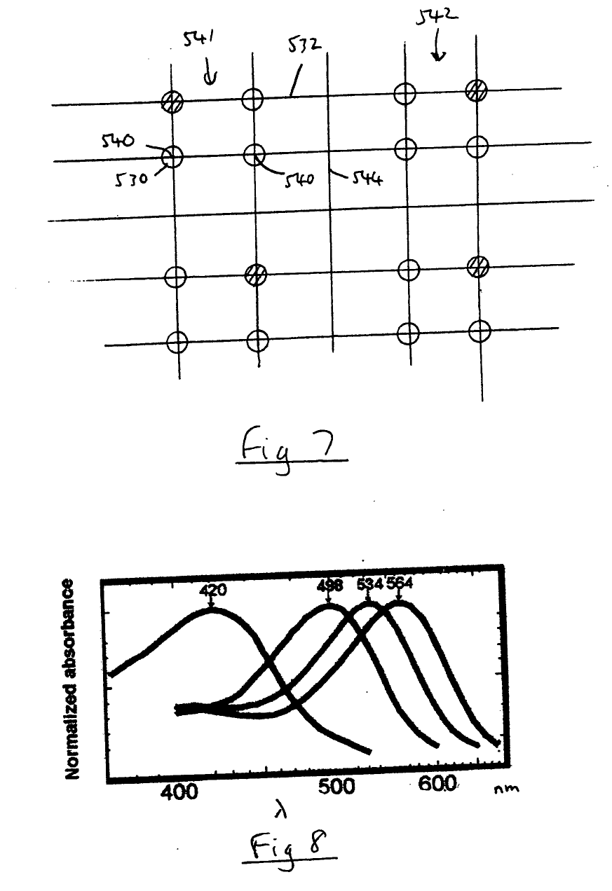

Referring to FIG. 7, in a further embodiment of the invention, the pattern is based around a square imaginary grid structure 532, but the dots 530 are arranged in groups of four with each dot centred on a respective grid intersection 540. The groups of dots are therefore each arranged in a square, with the spacing of the dots equal to the grid spacing. Between adjacent groups 541, 542, one grid line 544 is left free of dots, so that the distance between dots of two different groups is twice the distance between dots in the same group. It will of course be understood that the coding of positional information within the pattern of FIG. 7 can be arranged in the same way as the pattern of FIG. 2, or indeed in a similar manner to that of FIGS. 3 to 5, with single colour or composite dots. The method of reading the pattern is also similar to that of the previous embodiments and will not be described in detail.

It will also be appreciated that the grid lines in the embodiment of FIG. 7, as with the other embodiments, are purely imaginary, and used only to define the dot positions. In practice they are used to identify the position within the pattern by means of horizontal and vertical coordinates, that correspond to the positions of the grid lines shown. The grid could of course be a different shape, such as hexagonal and the groups of dots arranged in other shapes or relative positions as required.

In all of the embodiments described above, the same, or substantially the same, amount of ink of each colour is used in each group of pattern elements. This means that the light reflected from each group has, overall, substantially the same spectral content. However this is not always necessary for producing groups of pattern elements that appear the same colour to the human eye. Referring to FIG. 8, the eye uses rods and cones to detect light. The rods are more sensitive to low levels of light and are used more in low light conditions, and the cones are less sensitive to light, but detect light at three different wavelengths, and so enable the eye to distinguish different colours. The rods have highest sensitivity at 498 nm which is towards the longer wavelengths of the blue part of the spectrum. The cones have highest sensitivities at 420 nm (blue) 534 nm (green) and 564 nm (red). The brain distinguishes different colours based on the relative amounts of light detected by the three different cones. Therefore, if two inks, or combinations of inks, reflect light that will produce the same relative responses in the three cone types, then those two inks or combinations will appear the same colour. For example yellow light is of a wavelength between that at which the red and green cones are most sensitive. Therefore yellow light produces equal responses in the red and green cones. If red and green light is combined, a similar equal response is produced and this appears yellow to the human eye.

A result of this is that groups of pattern elements can be made to have the same average colour as perceived by the human eye, even if they reflect light at different wavelengths. The basic requirement is that each group of pattern elements should reflect light that, in total, produces equal-relative response in the three cone types. This enable use to be made of metameric colours. Metameric colours are colours that appear the same to the human eye, but are made up of different spectral content. For example an ink that reflects just yellow light, and one that reflects green and red can both appear yellow and so make up a metameric pair. Provided suitable inks are selected, these can be used to produce groups of pattern elements that have the same perceived colour.

For example, referring back to the embodiment of FIG. 4, in a modification to this embodiment, the three colours that can be printed are yellow, green and red, each being made up of an ink that reflects predominantly in a narrow band of wavelengths around the respective colour. Therefore the dots can be formed of one ink only, or a mixture of green and red. In order to be able to distinguish these it is important that the camera in the pen can distinguish between the various wavelengths. To the human eye, if the pattern were looked at very closely the different coloured dots could be distinguished, but those formed from a mixture of red and green would appear yellow. When looked at from a normal distance of around 50 cm, the pattern would appear uniformly yellow.

It will be appreciated that the amount of light reflected by the pattern elements at different wavelengths will depend on the light that is used to illuminate the pattern. However, but it can be assumed that, if the inks are chosen to have the desired appearance under an idealised white light with substantially constant intensity over the range of visible wavelengths, then it will have substantially the desired appearance under most normal lighting conditions.

Clearly other colours of ink can be used to print the pattern. For example the colours may be red, blue and green, or they may include other colours such as black.

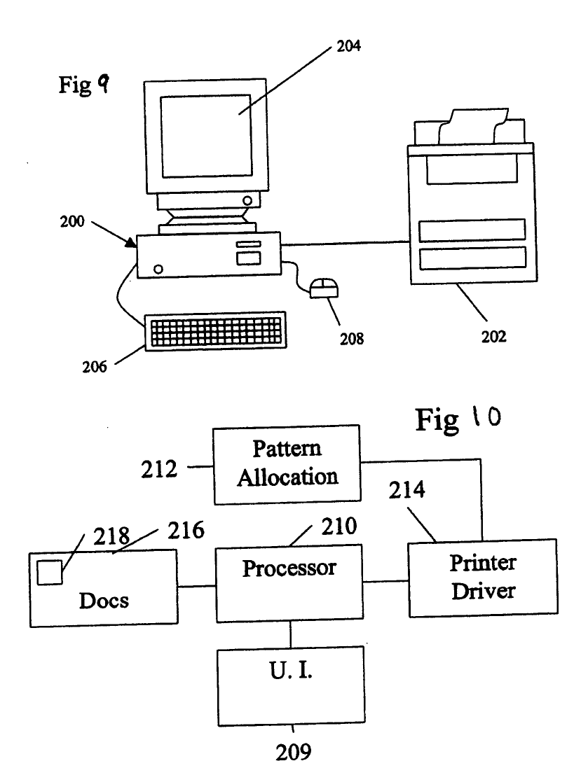

Referring to FIGS. 9 and 10, a very simple system for producing printed documents having the position identifying pattern on them comprises a personal computer (PC) 200 and a printer 202. The PC 200 has a screen 204, a keyboard 206 and a mouse 208 connected to it to provide a user interface 209 as shown generally in FIG. 10. As also shown in FIG. 10, the PC 200 comprises a processor 210 and a pattern allocation module 212 which is a software module stored in memory. The pattern allocation module 212 includes a definition of a total area of pattern space and a record of which parts of that total area have been allocated to specific documents, for example by means of coordinate references. The PC 200 further comprises a printer driver 214, which is a further software module, and a memory 216 having electronic documents 218 stored in it. The user interface 209 allows a user to interact with the PC 200.

In order to produce the printed document 2 with the pattern of FIG. 2, the processor 210 retrieves an electronic document 218 from the memory 216 and sends it to the printer driver. The electronic document 218 contains a definition of the content 7, and the areas of the document 2 which are to have the pattern 6 printed on it. The printer driver 214 requests the required amount of pattern from the pattern allocation module 212 which allocates by means of coordinate references an area of the pattern space to the document, and generates the pattern 6 for that area using a pattern generation algorithm. The algorithm is arranged to generate from the pattern coordinates the positions of all of the dots that make up the area of pattern, and the colour or colours if ink that are to be used to produce each dot. The pattern allocation module 212 communicates the details of the pattern including the positions of all the required dots of each colour of ink, back to the printer driver 214. The printer driver 214 then combines the content 7 and the pattern 6 into a single file which contains an image including the pattern and the content, converts the content 7 and the pattern 6 to a format suitable for the printer 202, and sends it to the printer which prints the content 7 and the pattern 6 simultaneously as a single image. The printer is therefore controlled to apply ink of the required colour or colours in each of the dot positions to make up the single colour and composite dots. Clearly the other patterns described above can be generated and printed in a similar manner to that of FIG. 2.

In practice the various components of the system can be spread out over a local network or the internet. For example the pattern allocation module 212 can be provided on a separate internet connected server so that it can be accessed by a number of users.

For the pattern of FIGS. 2 to 6, relatively low resolution printer can be used, such as a 600 dpi (dots per inch) ink jet or laser jet printer. In this case the spacing of the printer dots is around 41.6 μm so the pattern can be printed with sufficient accuracy for the pen to be able to read it.

While the patterns described above are position identifying patterns, the pattern can be used to encode other types of data.

We claim:

1. A product having a region of data encoding pattern thereon, the pattern being formed from groups of marks each group occupying a respective area of the product, wherein the marks are of different colours and the groups are arranged to have the same average colour as each other.

2. A product according to claim 1 wherein each group has a plurality of mark positions, each group has the same number of mark positions, and the pattern is arranged such that each mark position is characterised by at least one of: the presence of a mark of one of the colours; the colour of the mark; and the absence of a mark.

3. A product according to claim 1 wherein the areas of the product are the same size as each other.

4. A product according to claim 1 wherein each group of marks is formed from the same number of marks.

5. A product according to claim 1 wherein each of the marks is substantially the same size.

6. A product according to claim 1 wherein the marks are formed from marking materials of different marking material colours, and each of the groups is formed by applying substantially the same amount of marking material of each of the marking material colours to the product.

7. A product according to claim 1 wherein some of the marks are produced by the application of marking material of two different colours in the same mark position.

8. A product according to claim 1 wherein said groups are averaging groups and the marks are grouped spatially in spatial groups.

9. A product according to claim 8 wherein the averaging groups are the same groups as the spatial groups.

10. A product according to claim 8 wherein the spatial groups are defined by the spacing of the marks.

11. A product according to claim 8 wherein the positioning of the marks in each spatial group is asymmetrical so that the orientation of the pattern can be at least partially determined from the positions of the marks.

12. A product according to claim 1 wherein each of the groups of marks is arranged to reflect light of substantially the same spectral content over the visible spectrum.

13. A product according to claim 1 wherein each group of marks is arranged to reflect light that will produce substantially the same relative response in each of the cone types of the human eye.

14. A method of generating a data encoding pattern region, the method comprising defining the positions and colours of a plurality of groups of marks, such that each group is arranged to occupy a respective area, and such that the marks are of different colours and each group is arranged to have the same average colour as each other.

15. A system for applying a data encoding pattern region to a product, the system being arranged to define the positions and colours of a plurality of groups of marks, such that each group is arranged to occupy a respective area, and such that the marks are of different colours and each group is arranged to have the same average colour as each other, and to apply the pattern to the product.

16. A data carrier carrying data arranged to control a computer system to perform the method of claim 14.
